(19) United States
(12) Patent Application Publication
(10) Pub. No.: US 2024/0314841 A1
(43) Pub. Date: Sep. 19, 2024

(54) UPLINK ALIGNMENT APPLICATION PROGRAMMING INTERFACE (API) FOR LOW-LATENCY LOW-POWER APPLICATIONS

(71) Applicant: QUALCOMM Incorporated, San Diego, CA (US)

(72) Inventors: Prashanth Haridas Hande, San Diego, CA (US); Leena Zacharias, San Jose, CA (US); Arnaud Meylan, San Diego, CA (US); Mickael Mondet, Louannec (FR); Ravi Agarwal, San Diego, CA (US); Karen Yvonne Weeks, Encinitas, CA (US); Peerapol Tinnakornsrisuphap, San Diego, CA (US); Hyun Yong Lee, San Diego, CA (US); Zhichao Zhou, Beijing (CN); Pulkit Hanswal, Sunnyvale, CA (US)

(21) Appl. No.: 18/573,029

(22) PCT Filed: Aug. 16, 2021
(86) PCT No.: PCT/CN2021/112686

§ 371 Date: Dec. 21, 2023

(51) Int. Cl. H04W 74/0816; H04W 56/00; H04W 76/28

(52) U.S. Cl. CPC H04W 74/0816; H04W 56/0045; H04W 76/28

(57) ABSTRACT

This disclosure provides systems, methods, and devices for wireless communication that support mechanisms for uplink traffic alignment and/or uplink traffic aggregation in wireless communication systems. A user equipment (UE) is configured with a mechanism for signaling uplink transmit opportunities to an application client using an application programming interface (API) disposed between a modem of the UE and the application client that enables uplink traffic generated by the application client to be aligned. The API includes semi-static parameters that may be used when a common timer is configured between the application client and the modem, and/or dynamic parameters that may be used when a common timer is not configured between the application client and the modem. The API may also include an extended signaling scheme that may include no-transmission (No-Tx) indications that indicate intervals during which no transmissions are allowed. These No-Tx parameters apply to the semi-static and/or dynamic signaling scheme.

### TECHNICAL FIELD

Aspects of the present disclosure relate generally to wireless communication systems, and more particularly, to uplink alignment techniques for low-latency and low-power applications.

### INTRODUCTION

Wireless communication networks are widely deployed to provide various communication services such as voice, video, packet data, messaging, broadcast, and the like. These wireless networks may be multiple-access networks capable of supporting multiple users by sharing the available network resources. Such networks may be multiple access networks that support communications for multiple users by sharing the available network resources.

A wireless communication network may include several components. These components may include wireless communication devices, such as base stations (or node Bs) that may support communication for a number of user equipments (UEs). A UE may communicate with a base station via downlink and uplink. The downlink (or forward link) refers to the communication link from the base station to the UE, and the uplink (or reverse link) refers to the communication link from the UE to the base station.

A base station may transmit data and control information on a downlink to a UE or may receive data and control information on an uplink from the UE. On the downlink, a transmission from the base station may encounter interference due to transmissions from neighbor base stations or from other wireless radio frequency (RF) transmitters. On the uplink, a transmission from the UE may encounter interference from uplink transmissions of other UEs communicating with the neighbor base stations or from other wireless RF transmitters. This interference may degrade performance on both the downlink and uplink.

As the demand for mobile broadband access continues to increase, the possibilities of interference and congested networks grows with more UEs accessing the long-range wireless communication networks and more short-range wireless systems being deployed in communities. Research and development continue to advance wireless technologies not only to meet the growing demand for mobile broadband access, but to advance and enhance the user experience with mobile communications.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In one aspect of the disclosure, a method of wireless communication performed by a user equipment (UE) includes receiving, from a base station, an indication of at least one uplink transmit opportunity, and executing one or more function calls of an application programming interface (API) to signal the at least one uplink transmit opportunity to an application client of the UE. In aspects, the API is disposed between the application client and a modem of the UE. The method also includes aligning, based on the one or more function calls of the API, uplink packets generated by the application client to the at least one uplink transmit opportunity, and transmitting, using the modem, an uplink transmission including the uplink packets to the base station during the at least one uplink transmit opportunity.

In an additional aspect of the disclosure, a UE includes at least one processor and a memory coupled to the at least one processor. The at least one processor stores processor-readable code that, when executed by the at least one processor, is configured to perform operations including receiving, from a base station, an indication of at least one uplink transmit opportunity, and executing one or more function calls of an API to signal the at least one uplink transmit opportunity to an application client of the UE. In aspects, the API is disposed between the application client and a modem of the UE. The operations also includes aligning, based on the one or more function calls of the API, uplink packets generated by the application client to the at least one uplink transmit opportunity, and transmitting, using the modem, an uplink transmission including the uplink packets to the base station during the at least one uplink transmit opportunity.

In an additional aspect of the disclosure, a non-transitory computer-readable medium stores instructions that, when executed by a processor, cause the processor to perform operations. The operations include receiving, from a base station, an indication of at least one uplink transmit opportunity, and executing one or more function calls of an API to signal the at least one uplink transmit opportunity to an application client of the UE. In aspects, the API is disposed between the application client and a modem of the UE. The operations also includes aligning, based on the one or more function calls of the API, uplink packets generated by the application client to the at least one uplink transmit opportunity, and transmitting, using the modem, an uplink transmission including the uplink packets to the base station during the at least one uplink transmit opportunity.

In an additional aspect of the disclosure, an apparatus includes means for receiving, from a base station, an indication of at least one uplink transmit opportunity, and means for executing one or more function calls of an API to signal the at least one uplink transmit opportunity to an application client of the UE. In aspects, the API is disposed between the application client and a modem of the UE. The apparatus also includes means for aligning, based on the one or more function calls of the API, uplink packets generated by the application client to the at least one uplink transmit opportunity, and means for transmitting, using the modem, an uplink transmission including the uplink packets to the base station during the at least one uplink transmit opportunity.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating details of an example wireless communication system according to one or more aspects.

FIG. 2 is a block diagram illustrating examples of a base station and a user equipment (UE) according to one or more aspects.

FIG. 3 is a block diagram of an example wireless communications system that supports mechanisms for uplink traffic alignment and uplink traffic aggregation in a wireless communication system according to one or more aspects of the present disclosure.

FIG. 4A is a block diagram illustrating an example of a general approach for uplink traffic alignment enabled by an application programming interface (API) in accordance with aspects of the present disclosure.

FIG. 4B is a block diagram illustrating an example of uplink traffic alignment enabled by an API in accordance with aspects of the present disclosure.

FIG. 4C is a block diagram illustrating an example of a connected discontinuous reception (CDRX) mismatch.

FIG. 5 is a flow diagram illustrating an example process that supports mechanisms for uplink traffic alignment and uplink traffic aggregation in a wireless communication system according to one or more aspects.

FIG. 6 is a block diagram of an example UE that supports mechanisms for uplink traffic alignment and uplink traffic aggregation in a wireless communication system according to one or more aspects.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

This disclosure relates generally to providing or participating in authorized shared access between two or more wireless devices in one or more wireless communications systems, also referred to as wireless communications networks. In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5^{th} Generation (5G) or new radio (NR) networks (sometimes referred to as “5G NR” networks, systems, or devices), as well as other communications networks. As described herein, the terms “networks” and “systems” may be used interchangeably.

A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may, for example implement a radio technology such as Global System for Mobile Communication (GSM). The 3rd Generation Partnership Project (3GPP) defines standards for the GSM EDGE (enhanced data rates for GSM evolution) radio access network (RAN), also denoted as GERAN. GERAN is the radio component of GSM/EDGE, together with the network that joins the base stations (for example, the Ater and Abis interfaces) and the base station controllers (A interfaces, etc.). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may comprise one or more GERANs, which may be coupled with UTRANs in the case of a UMTS/GSM network. Additionally, an operator network may also include one or more LTE networks, or one or more other networks. The various different network types may use different radio access technologies (RATs) and RANs.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3GPP is a collaboration between groups of telecommunications associations that aims to define a globally applicable third generation (3G) mobile phone specification. 3GPP LTE is a 3GPP project which was aimed at improving UMTS mobile phone standard. The 3GPP may define specifications for the next generation of mobile networks, mobile systems, and mobile devices. The present disclosure may describe certain aspects with reference to LTE, 4G, or 5G NR technologies; however, the description is not intended to be limited to a specific technology or application, and one or more aspects described with reference to one technology may be understood to be applicable to another technology. Additionally, one or more aspects of the present disclosure may be related to shared access to wireless spectrum between networks using different radio access technologies or radio air interfaces.

5G networks contemplate diverse deployments, diverse spectrum, and diverse services and devices that may be implemented using an OFDM-based unified, air interface. To achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ˜1 M nodes/km²), ultra-low complexity (e.g., ˜10 s of bits/sec), ultra-low energy (e.g., ˜ 10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜ 1 millisecond (ms)), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

Devices, networks, and systems may be configured to communicate via one or more portions of the electromagnetic spectrum. The electromagnetic spectrum is often subdivided, based on frequency or wavelength, into various classes, bands, channels, etc. In 5G NR two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” (mmWave) band in documents and articles, despite being different from the extremely high frequency (EHF) band (30 GHz-300 GHz) which is identified by the International Telecommunications Union (ITU) as a “mmWave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “mmWave” or the like if used herein may broadly represent frequencies that may include mid-band frequencies, may be within FR2, or may be within the EHF band.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD) design or frequency division duplex (FDD) design; and advanced wireless technologies, such as massive multiple input, multiple output (MIMO), robust mmWave transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD or TDD implementations, subcarrier spacing may occur with 15 kHz, for example over 1, 5, 10, 20 MHz, and the like bandwidth. For other various outdoor and small cell coverage deployments of TDD greater than 3 GHz, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mmWave components at a TDD of 28 GHz, subcarrier spacing may occur with 120 kHz over a 500 MHz bandwidth.

The scalable numerology of 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink or downlink scheduling information, data, and acknowledgement in the same subframe. The self-contained integrated subframe supports communications in unlicensed or contention-based shared spectrum, adaptive uplink or downlink that may be flexibly configured on a per-cell basis to dynamically switch between uplink and downlink to meet the current traffic needs.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur. Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, and constitution.

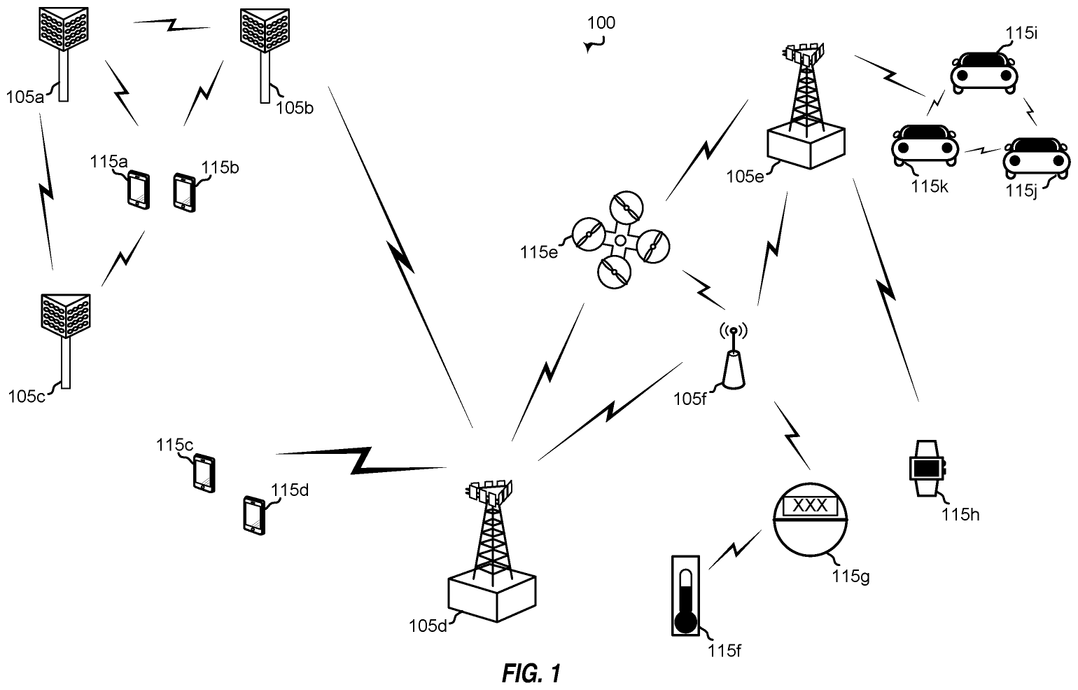

FIG. 1 is a block diagram illustrating details of an example wireless communication system according to one or more aspects. The wireless communication system may include wireless network 100. Wireless network 100 may, for example, include a 5G wireless network. As appreciated by those skilled in the art, components appearing in FIG. 1 are likely to have related counterparts in other network arrangements including, for example, cellular-style network arrangements and non-cellular-style-network arrangements (e.g., device to device or peer to peer or ad hoc network arrangements, etc.).

Wireless network 100 illustrated in FIG. 1 includes a number of base stations 105 and other network entities. A base station may be a station that communicates with the UEs and may also be referred to as an evolved node B (eNB), a next generation eNB (gNB), an access point, and the like. Each base station 105 may provide communication coverage for a particular geographic area. In 3GPP, the term “cell” may refer to this particular geographic coverage area of a base station or a base station subsystem serving the coverage area, depending on the context in which the term is used. In implementations of wireless network 100 herein, base stations 105 may be associated with a same operator or different operators (e.g., wireless network 100 may include a plurality of operator wireless networks). Additionally, in implementations of wireless network 100 herein, base station 105 may provide wireless communications using one or more of the same frequencies (e.g., one or more frequency bands in licensed spectrum, unlicensed spectrum, or a combination thereof) as a neighboring cell. In some examples, an individual base station 105 or UE 115 may be operated by more than one network operating entity. In some other examples, each base station 105 and UE 115 may be operated by a single network operating entity.

A base station may provide communication coverage for a macro cell or a small cell, such as a pico cell or a femto cell, or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 1, base stations 105d and 105e are regular macro base stations, while base stations 105a-105c are macro base stations enabled with one of 3 dimension (3D), full dimension (FD), or massive MIMO. Base stations 105a-105c take advantage of their higher dimension MIMO capabilities to exploit 3D beamforming in both elevation and azimuth beamforming to increase coverage and capacity. Base station 105f is a small cell base station which may be a home node or portable access point. A base station may support one or multiple (e.g., two, three, four, and the like) cells.

Wireless network 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 115 are dispersed throughout the wireless network 100, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component, vehicular device, or vehicular module, or some other suitable terminology. Within the present document, a “mobile” apparatus or UE need not necessarily have a capability to move, and may be stationary. Some non-limiting examples of a mobile apparatus, such as may include implementations of one or more of UEs 115, include a mobile, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A mobile apparatus may additionally be an IoT or “Internet of everything” (IoE) device such as an automotive or other transportation vehicle, a satellite radio, a global positioning system (GPS) device, a global navigation satellite system (GNSS) device, a logistics controller, a drone, a multi-copter, a quad-copter, a smart energy or security device, a solar panel or solar array, municipal lighting, water, or other infrastructure; industrial automation and enterprise devices; consumer and wearable devices, such as eyewear, a wearable camera, a smart watch, a health or fitness tracker, a mammal implantable device, gesture tracking device, medical device, a digital audio player (e.g., MP3 player), a camera, a game console, etc.; and digital home or smart home devices such as a home audio, video, and multimedia device, an appliance, a sensor, a vending machine, intelligent lighting, a home security system, a smart meter, etc. In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 115a-115d of the implementation illustrated in FIG. 1 are examples of mobile smart phone-type devices accessing wireless network 100 A UE may also be a machine specifically configured for connected communication, including machine type communication (MTC), enhanced MTC (eMTC), narrowband IoT (NB-IoT) and the like. UEs 115e-115k illustrated in FIG. 1 are examples of various machines configured for communication that access wireless network 100.

A mobile apparatus, such as UEs 115, may be able to communicate with any type of the base stations, whether macro base stations, pico base stations, femto base stations, relays, and the like. In FIG. 1, a communication link (represented as a lightning bolt) indicates wireless transmissions between a UE and a serving base station, which is a base station designated to serve the UE on the downlink or uplink, or desired transmission between base stations, and backhaul transmissions between base stations. UEs may operate as base stations or other network nodes in some scenarios. Backhaul communication between base stations of wireless network 100 may occur using wired or wireless communication links.

In operation at wireless network 100, base stations 105a-105c serve UEs 115a and 115b using 3D beamforming and coordinated spatial techniques, such as coordinated multipoint (CoMP) or multi-connectivity. Macro base station 105d performs backhaul communications with base stations 105a-105c, as well as small cell, base station 105f. Macro base station 105d also transmits multicast services which are subscribed to and received by UEs 115c and 115d. Such multicast services may include mobile television or stream video, or may include other services for providing community information, such as weather emergencies or alerts, such as Amber alerts or gray alerts.

Wireless network 100 of implementations supports mission critical communications with ultra-reliable and redundant links for mission critical devices, such UE 115e, which is a drone. Redundant communication links with UE 115e include from macro base stations 105d and 105e, as well as small cell base station 105f. Other machine type devices, such as UE 115f (thermometer), UE 115g (smart meter), and UE 115h (wearable device) may communicate through wireless network 100 either directly with base stations, such as small cell base station 105f, and macro base station 105e, or in multi-hop configurations by communicating with another user device which relays its information to the network, such as UE 115f communicating temperature measurement information to the smart meter, UE 115g, which is then reported to the network through small cell base station 105f. Wireless network 100 may also provide additional network efficiency through dynamic. low-latency TDD communications or low-latency FDD communications, such as in a vehicle-to-vehicle (V2V) mesh network between UEs 115i-115k communicating with macro base station 105c.

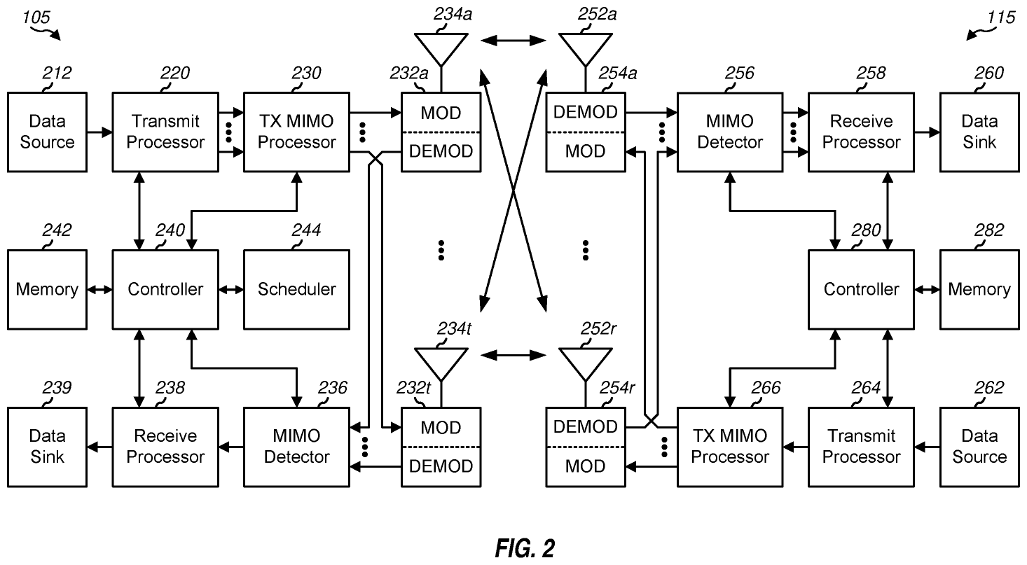

FIG. 2 is a block diagram illustrating examples of base station 105 and UE 115 according to one or more aspects. Base station 105 and UE 115 may be any of the base stations and one of the UEs in FIG. 1. For a restricted association scenario (as mentioned above), base station 105 may be small cell base station 105f in FIG. 1, and UE 115 may be UE 115c or 115d operating in a service area of base station 105f, which in order to access small cell base station 105f, would be included in a list of accessible UEs for small cell base station 105f. Base station 105 may also be a base station of some other type. As shown in FIG. 2, base station 105 may be equipped with antennas 234a through 234t, and UE 115 may be equipped with antennas 252a through 252r for facilitating wireless communications.

At base station 105, transmit processor 220 may receive data from data source 212 and control information from controller 240, such as a processor. The control information may be for a physical broadcast channel (PBCH), a physical control format indicator channel (PCFICH), a physical hybrid-ARQ (automatic repeat request) indicator channel (PHICH), a physical downlink control channel (PDCCH), an enhanced physical downlink control channel (EPDCCH), an MTC physical downlink control channel (MPDCCH), etc. The data may be for a physical downlink shared channel (PDSCH), etc. Additionally, transmit processor 220 may process (e.g., encode and symbol map) the data and control information to obtain data symbols and control symbols, respectively. Transmit processor 220 may also generate reference symbols, e.g., for the primary synchronization signal (PSS) and secondary synchronization signal (SSS), and cell-specific reference signal. Transmit (TX) MIMO processor 230 may perform spatial processing (e.g., precoding) on the data symbols, the control symbols, or the reference symbols, if applicable, and may provide output symbol streams to modulators (MODs) 232a through 232t. For example, spatial processing performed on the data symbols, the control symbols, or the reference symbols may include precoding. Each modulator 232 may process a respective output symbol stream (e.g., for OFDM, etc.) to obtain an output sample stream. Each modulator 232 may additionally or alternatively process (e.g., convert to analog, amplify, filter, and upconvert) the output sample stream to obtain a downlink signal. Downlink signals from modulators 232a through 232t may be transmitted via antennas 234a through 234t, respectively.

At UE 115, antennas 252a through 252r may receive the downlink signals from base station 105 and may provide received signals to demodulators (DEMODs) 254a through 254r, respectively. Each demodulator 254 may condition (e.g., filter, amplify, downconvert, and digitize) a respective received signal to obtain input samples. Each demodulator 254 may further process the input samples (e.g., for OFDM, etc.) to obtain received symbols. MIMO detector 256 may obtain received symbols from demodulators 254a through 254r, perform MIMO detection on the received symbols if applicable, and provide detected symbols. Receive processor 258 may process (e.g., demodulate, deinterleave, and decode) the detected symbols, provide decoded data for UE 115 to data sink 260, and provide decoded control information to controller 280, such as a processor.

On the uplink, at UE 115, transmit processor 264 may receive and process data (e.g., for a physical uplink shared channel (PUSCH)) from data source 262 and control information (e.g., for a physical uplink control channel (PUCCH)) from controller 280. Additionally, transmit processor 264 may also generate reference symbols for a reference signal. The symbols from transmit processor 264 may be precoded by TX MIMO processor 266 if applicable, further processed by modulators 254a through 254r (e.g., for SC-FDM, etc.), and transmitted to base station 105. At base station 105, the uplink signals from UE 115 may be received by antennas 234, processed by demodulators 232, detected by MIMO detector 236 if applicable, and further processed by receive processor 238 to obtain decoded data and control information sent by UE 115. Receive processor 238 may provide the decoded data to data sink 239 and the decoded control information to controller 240.

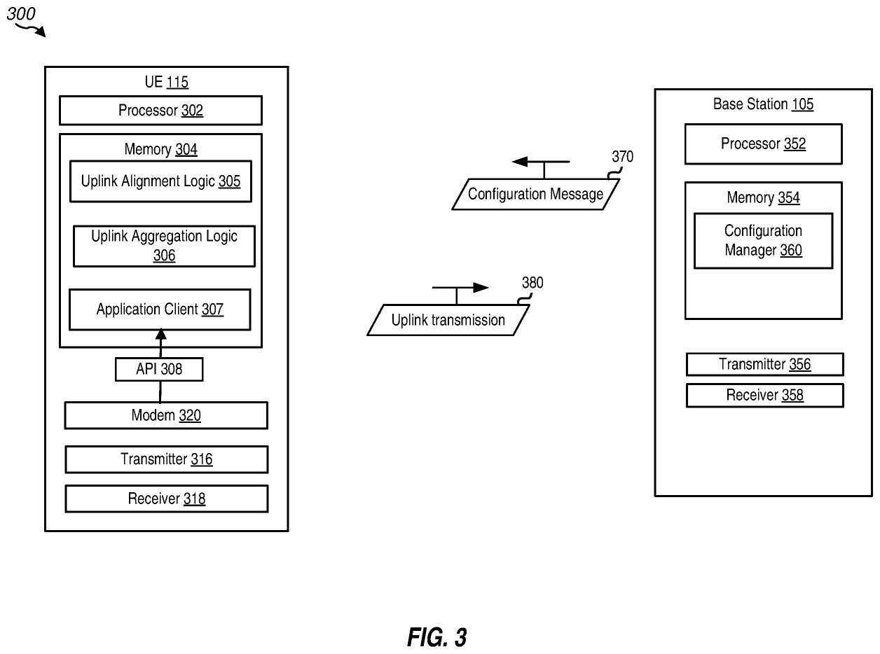

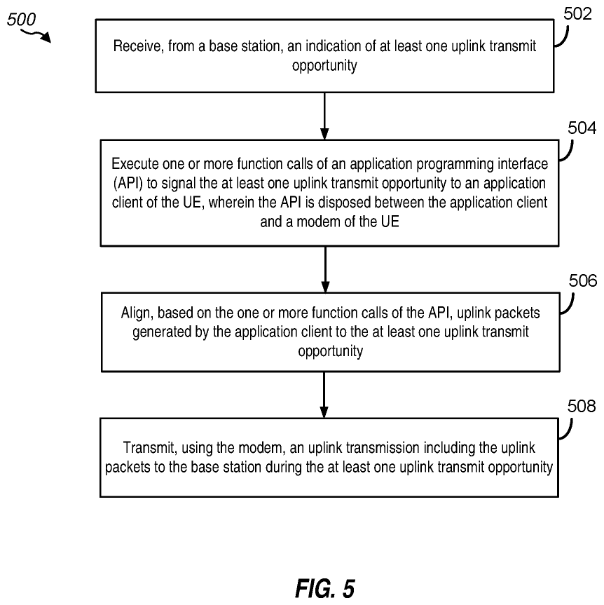

Controllers 240 and 280 may direct the operation at base station 105 and UE 115, respectively. Controller 240 or other processors and modules at base station 105 or controller 280 or other processors and modules at UE 115 may perform or direct the execution of various processes for the techniques described herein, such as to perform or direct the execution illustrated in FIGS. 3 and 5, or other processes for the techniques described herein. Memories 242 and 282 may store data and program codes for base station 105 and UE 115, respectively. Scheduler 244 may schedule UEs for data transmission on the downlink or the uplink.

In some cases, UE 115 and base station 105 may operate in a shared radio frequency spectrum band, which may include licensed or unlicensed (e.g., contention-based) frequency spectrum. In an unlicensed frequency portion of the shared radio frequency spectrum band, UEs 115 or base stations 105 may traditionally perform a medium-sensing procedure to contend for access to the frequency spectrum. For example, UE 115 or base station 105 may perform a listen-before-talk or listen-before-transmitting (LBT) procedure such as a clear channel assessment (CCA) prior to communicating in order to determine whether the shared channel is available. In some implementations, a CCA may include an energy detection procedure to determine whether there are any other active transmissions. For example, a device may infer that a change in a received signal strength indicator (RSSI) of a power meter indicates that a channel is occupied. Specifically, signal power that is concentrated in a certain bandwidth and exceeds a predetermined noise floor may indicate another wireless transmitter. A CCA also may include detection of specific sequences that indicate use of the channel. For example, another device may transmit a specific preamble prior to transmitting a data sequence. In some cases, an LBT procedure may include a wireless node adjusting its own backoff window based on the amount of energy detected on a channel or the acknowledge/negative-acknowledge (ACK/NACK) feedback for its own transmitted packets as a proxy for collisions.

In current wireless communication systems, various applications configured to run on a UE may also be configured to take advantage of low-latency and low-power approaches. For example, voice over internet protocol (VoIP), voice over LTE (VOLTE), or other communication applications (e.g., WhatsApp, Facetime, etc.), are examples of applications that may take advantage of, or in some implementations may require, low-latency due to end-to-end communication requirements. These applications also may require a low-power approach in order to conserve battery power of the UE to extend talk time. Another example of applications requiring a low-latency and low-power approach is extended reality (XR) applications, which may include augmented reality (AR), virtual reality (VR), mixed reality (MR), etc. In particular, split XR applications, in which the XR computations (e.g., XR environment rendering, position or orientation determining, etc.) may be split between a rendering server and an application client running on an XR device (e.g., the UE), may require low-latency in order to reduce lag between the communications between the UE and the rendering server and to provide an adequate user experience, and/or may require low-power techniques in order to conserve battery power of the UE, to extend UE operating time, and/or to enable small factor XR devices (e.g., small factor UEs).

In split-XR applications, the rendering server may be used to render the XR environment to be displayed in the UE display running the application client. More precisely, the rendering server may render the different XR views that are to be presented depending on pose information of the UE (e.g., any one of location, position, and/or orientation information, or a combination of therefrom). In these implementations, the UE may transmit pose information to a base station, which may in turn transmit this info to the rendering server. A view of the XR environment may be rendered by the rendering server, and the rendered data may be transmitted, e.g., via a base station over a downlink, to the UE, in which the application client may receive the rendered data to be displayed.

In current implementations, an application client running on the UE may leverage the communication capabilities of the UE to perform operations. For example, an application client may receive downlink transmissions and may transmit uplink transmissions via a modem of the UE. The UE may receive downlink transmission (e.g., from a base station) via its modem, and the downlink transmissions may be provided to the application client. In some cases, the application client may have data to be sent over the uplink, in which case the uplink data may be provided to the modem, and then sent to the base station (or rendering server) by the modem. In each case (e.g., either when sending uplink data or when receiving downlink data), the modem needs to be powered up to transmit or receive the data. This may limit the opportunities for the modem to enter a sleep mode as the modem needs to be on in order to transmit or receive. As such, when the uplink transmissions are not aligned to downlink receptions, the modem needs to be on when receiving and then on again when transmitting on the uplink, which reduces the opportunities for the modem to sleep (and thus conserve power).

This problem with current implementations is particularly significant in split-XR applications, as the server rendering time is typically adaptive to reduce motion-to-render-to-photon (M2R2P) round trip time at the application level. The M2R2P round trip time is typically what drives user experience in split XR applications. For example, in a server, a render start time may be set based on a frame repeat and asynchronous time warp (ATW) repeat statistics, and/or the render start time may be set to immediately follow pose information arrival or a timeout. The resulting arrival time of a burst on the uplink and downlink may thus be suboptimal. For example, the gaps (e.g., gaps between downlink receptions and uplink transmissions) available for modem sleep may be reduced. However, in these situations, aligning uplink traffic may increase modem sleep opportunities. For example, feedback from the 5G NR layer towards the application layer may be used to modify uplink traffic pattern, and/or a cross-layer design may be used for joint optimization of end-to-end latency and power.

In some implementations, connected discontinuous reception (CDRX) may be used to realize power savings. A UE configured for CDRX may be configured to enter sleep mode during CDRX off times, during which no downlink or uplink transmissions may take place. Depending on the duration of the sleep mode during the CDRX off times and depending on the number of CDRX off times, the power savings realized may be significant, as the modem may be turned off during CDRX off times. In some implementations, bandwidth part (BWP) switching may be used to decrease power usage. For example, the UE may be configured with more than one BWP (e.g., a high-throughput BWP and a low-power BWP). In these implementations, the UE may use the high-throughput BWP when downlink traffic is to be received, and may use the low-power BWP when there is no downlink traffic to be received. However, in both CDRX and BWP switching implementations, there are time periods in which no operations on the air interface are performed (e.g., no downlink or uplink transmissions take place). For example, during transition periods in which enters or exits a sleep mode for CDRX (e.g., enters or exits CDRX off times), and/or during times in which the UE transitions between the high-throughput BWP and a low-power BWP. In these cases, if the duration of an uplink transmission is lower than the duration of the transition times, there are no power savings from the CDRX and/or BWP switching features.

Various aspects of the present disclosure are directed to systems and methods that support mechanisms for uplink traffic alignment and/or uplink traffic aggregation in wireless communication systems. In particular aspects, a signaling mechanism is provided that provides for signaling uplink transmit opportunities to an application client using an application programming interface (API) that enables uplink traffic alignment and/or uplink traffic aggregation in accordance with aspects of the present disclosure. For example, an API may be provided between a modem of a UE and an application client that enables the uplink traffic generated by the application client to be aligned, thereby providing an improved control of the available gaps for sleeping for the modem. In some aspects, the API may include semi-static parameters that may be used when a common timer is configured between the application client and the modem, and/or dynamic parameters that may be used when a common timer is not configured between the application client and the modem. In some aspects, the API may include an extended signaling scheme that may include no-transmission (No-Tx) indications that may indicate periods or intervals in which no transmissions may be allowed. These No-Tx parameters may apply to the semi-static and/or dynamic signaling scheme.

In aspects, uplink traffic aggregation may be provided by configuring the UE to aggregate a number of uplink frames before transmitting the uplink frames on the air interface of the UE. For example, in some aspects, a latency tolerance API may be implemented to enable uplink traffic aggregation in accordance with aspects of the present disclosure. The latency tolerance API may include parameters that may allow an application client to indicate a tolerance for additional latency in return for reduced power consumption. By aggregating uplink frames, a UE configured in accordance with aspects of the present disclosure may enable fewer transmissions on the air interface, which may reduce the PUSCH transmission contribution to power consumption and may improve the uplink transmission capacity.

FIG. 3 is a block diagram of an example wireless communications system 300 that supports mechanisms for uplink traffic alignment and uplink traffic aggregation in a wireless communication system according to one or more aspects of the present disclosure. In some examples, wireless communications system 300 may implement aspects of wireless network 100. Wireless communications system 300 includes UE 115 and base station 105. Although one UE 115 and one base station 105 are illustrated, in some other implementations, wireless communications system 300 may generally include multiple UEs 115 and may include more than one base station 105.

UE 115 may include a variety of components (such as structural, hardware components) used for carrying out one or more functions described herein. For example, these components may include one or more processors 302 (hereinafter referred to collectively as “processor 302”), one or more memory devices 304 (hereinafter referred to collectively as “memory 304”), one or more transmitters 316 (hereinafter referred to collectively as “transmitter 316”), one or more receivers 318 (hereinafter referred to collectively as “receiver 318”), and one or more modems 320 (hereinafter referred to collectively as “modem 320”). Processor 302 may be configured to execute instructions stored in memory 304 to perform the operations described herein. In some implementations, processor 302 includes or corresponds to one or more of receive processor 258, transmit processor 264, and controller 280, and memory 304 includes or corresponds to memory 282. In aspects, a modem, as used herein, may refer to a combination of components (e.g., modulator and demodulators 254a-r, etc., as illustrated in FIG. 2 for UE 115) that may enable UE 115 to receive downlink transmissions from base station 105 and/or to transmit uplink transmissions to base station 105.

Memory 304 includes or is configured to store uplink alignment logic 305, uplink aggregation logic 306, and application client 307. In aspects, uplink alignment logic 305 is configured to perform operations for aligning uplink traffic in accordance with aspects of the present disclosure. In some aspects, uplink alignment logic 305 may be configured to perform operations for aligning uplink traffic by implementing an API between a modem of UE 115 and an application client running on UE 115. The API may implement function calls and/or parameters that may enable the application client to generate and provide uplink packets to the modem such that the uplink packets are aligned with on times (e.g., connected discontinuous reception (CDRX) on times) of the modem of UE 115. In this manner, uplink alignment logic 305 is configured to align uplink traffic.

In aspects, uplink aggregation logic 306 is configured to perform operations for aggregating uplink traffic in accordance with aspects of the present disclosure. In some aspects, uplink aggregation logic 306 may be configured to perform operations for aggregating uplink traffic by implementing a latency tolerance API between a modem of UE 115 and an application client running on UE 115. The latency tolerance API may implement function calls and/or parameters that may enable the modem to determine to aggregate uplink frames. In aspects, uplink aggregation logic 306 may be configured to enable the modem of UE 115 to determine an optimal number of uplink frames to be aggregated and/or stored before being transmitted on the air interface.

In aspects, application client 307 may represent an application, firmware, program, or any other software that may run on UE 115 and may perform operations that may leverage low-latency and or low-power features, as described above. In some aspects, application client 307 may represent an XR application (e.g., such as in a split-XR implementation) that may be configured to provide pose information (e.g., via an uplink transmission) to a rendering server, and may be configured to receive rendered data in response to the pose information transmission over a downlink (e.g., from base station 105) representing a rendered view by the rendering server. In aspects, application client may be configured to communicate with modem 320 via API 308. API 308 may be configured to enable uplink traffic alignment and/or uplink traffic aggregation in accordance with aspects of the present disclosure.

Transmitter 316 is configured to transmit reference signals, control information and data to one or more other devices, and receiver 318 is configured to receive references signals, synchronization signals, control information and data from one or more other devices. For example, transmitter 316 may transmit signaling, control information and data to, and receiver 318 may receive signaling, control information and data from base station 105. In some implementations, transmitter 316 and receiver 318 may be integrated in one or more transceivers. Additionally or alternatively, transmitter 316 or receiver 318 may include or correspond to one or more components of UE 115 described with reference to FIG. 2.

Base station 105 may include a variety of components (such as structural, hardware components) used for carrying out one or more functions described herein. For example, these components may include one or more processors 352 (hereinafter referred to collectively as “processor 352”), one or more memory devices 354 (hereinafter referred to collectively as “memory 354”), one or more transmitters 356 (hereinafter referred to collectively as “transmitter 356”), and one or more receivers 358 (hereinafter referred to collectively as “receiver 358”). Processor 352 may be configured to execute instructions stored in memory 354 to perform the operations described herein. In some implementations, processor 352 includes or corresponds to one or more of receive processor 238, transmit processor 220, and controller 240, and memory 354 includes or corresponds to memory 242.

Memory 354 includes or is configured to store configuration manager 360. Configuration manager 360 may be configured to perform operations for configuring UE 115 with CDRX and/or BWP switching operations, as described above. In some aspects, configuration manager 360 may be configured to include information about uplink transmit opportunities to UE 115. Uplink transmit opportunities may be determined, at least in part, by configuration manager 360 based on arrival times of downlink burst transmissions at the modem, and may be determined with respect to CDRX on times.

Transmitter 356 is configured to transmit reference signals, synchronization signals, control information and data to one or more other devices, and receiver 358 is configured to receive reference signals, control information and data from one or more other devices. For example, transmitter 356 may transmit signaling, control information and data to, and receiver 358 may receive signaling, control information and data from UE 115. In some implementations, transmitter 356 and receiver 358 may be integrated in one or more transceivers. Additionally or alternatively, transmitter 356 or receiver 358 may include or correspond to one or more components of base station 105 described with reference to FIG. 2.

In some implementations, wireless communications system 300 implements a 5G NR network. For example, wireless communications system 300 may include multiple 5G-capable UEs 115 and multiple 5G-capable base stations 105, such as UEs and base stations configured to operate in accordance with a 5G NR network protocol such as that defined by the 3GPP.

During operation of wireless communications system 300, base station 105 may provide configuration message 370 to UE 115. In aspects, configuration message 370 may represent a CDRX configuration and/or a BWP switching configuration for UE 115. The CDRX configuration may include an indication of uplink transmit opportunities available to the UE for transmitting uplink transmissions (e.g., uplink transmission 380) to base station 105. For example, uplink transmission 380 may include pose information that is intended for a rendering server in a split-XR implementation so that the rendering server may render an XR view that is then transmitted to UE 115 for display at UE 115. In aspects, uplink transmission 380 may represent an aligned uplink transmission in accordance with aspects of the present disclosure. In some aspects, uplink transmission 380 may represent an aggregated uplink transmission in accordance with aspects of the present disclosure.

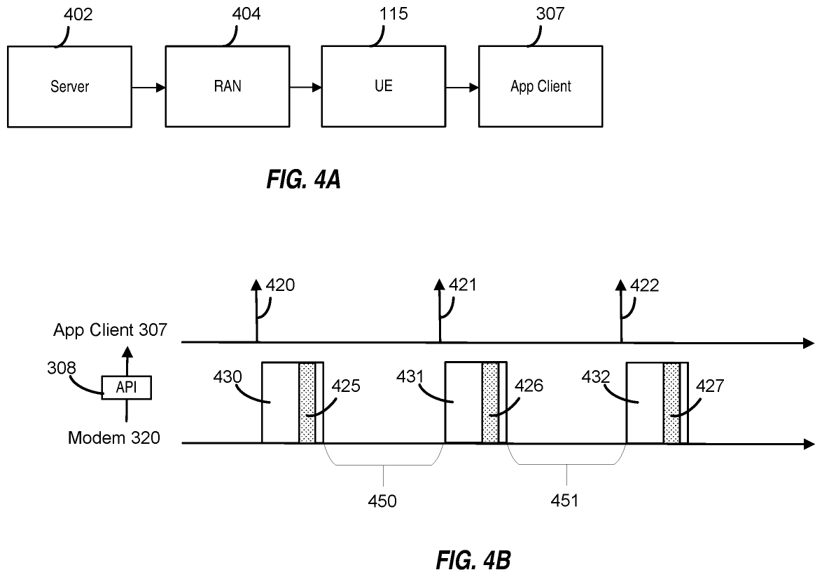

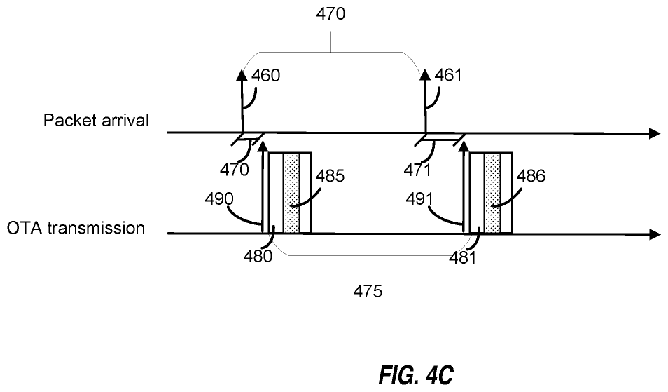

In aspects, as noted above, uplink transmission 380 may represent an aligned uplink transmission. For example, a signaling mechanism may be provided that provides parameters in an API (e.g., API 308) that may enable uplink traffic alignment. In aspects API 308 may be provided between modem 320 of UE 115 and application client 307. Uplink traffic generated by application client 307 may be aligned with CDRX on times, which may enable modem 320 to leverage the available gaps between the CDRX on time, thereby providing improved opportunities for power savings. Before discussing the particular details and parameters of API 308, a discussion of a discussion of the general approach for uplink traffic alignment enabled by API 308 will be discussed with respect to FIGS. 4A and 4B.

In some aspects, the signaling scheme provided by API 308 of aspects may enable the UE to leverage knowledge of uplink transmission opportunities in order to align the uplink traffic generated by the application client. FIG. 4A is a block diagram illustrating an example of a general approach for uplink traffic alignment enabled by the API in accordance with aspects of the present disclosure. As shown in FIG. 4A, a server 402, which may include an edge server, a rendering server, etc., may be configured to communicate with radio access network (RAN) 404 (e.g., which may include base station 105). Server 302 may be configured to signal to RAN 304 burst arrival times for downlink traffic. The burst arrival times for downlink traffic may indicate times at which bursts of downlink traffic are to arrive at modem 320 of UE 115 (e.g., via wireless radios and antennas of UE 115). In some aspects, RAN 304 may learn the burst arrival times for downlink traffic. As will be appreciated, UE 115 may need to be awake or powered up in order to receive the downlink traffic bursts at the arrival times.

In aspects, RAN 304 (e.g., including base station 105) may analyze (e.g., using an algorithm) the arrival times for downlink traffic signaled by or learned from server 302. RAN 304 may generate CDRX settings for UE 115 based on the arrival times for downlink traffic. For example, RAN 304 may generate CDRX settings for UE 115 configuring UE 115 with CDRX on times and CDRX off times based on the downlink burst arrival times. In this manner, UE 115 may ensure that modem 320 is on (e.g., in a CDRX on time) when the downlink burst arrives at UE 306, and may be configured with CDRX off times for sleeping when no downlink bursts are to arrive at UE 115. In some aspects, RAN 304 (e.g., via base station 105) may also determine or set uplink transmit opportunities based on the downlink burst arrival times signaled by or learned from server 302 and/or scheduling delays. In some aspects, the uplink transmit opportunities may be set or determined with respect to the CDRX on times configured in the CDRX settings. For example, uplink transmit opportunities may be set to begin with respect to a CDRX on time (e.g., shortly prior to, during, or shortly after a CDRX on time). In this manner, the uplink transmit opportunities may be aligned with the CDRX on times in the CDRX settings. RAN 304 may provide the CDRX settings, including the uplink transmit opportunities, to UE 115 (e.g., via configuration message 375).

UE 115 may receive the CDRX settings, including information about the uplink transmit opportunities, from RAN 304 (e.g., via base station 105). Information about the uplink transmit opportunities may be provided to application client 307 (e.g., from modem 320) via API 308 implemented in accordance with aspects of the present disclosure. Application client 307 may generate uplink packets to be provided to modem 320 of UE 115 based on the uplink transmit opportunities. For example, application client 307 may provide the uplink packets to modem 320 for uplink transmission during the uplink transmit opportunities. In this manner, modem 320 may sleep during CDRX off times, and may wake up during CDRX on times, while uplink transmissions may be aligned to the CDRX on times thereby preventing modem 320 from having to wake up again (e.g., between CDRX off times) in order to handle uplink traffic. These operations in accordance with aspects of the present disclosure are illustrated in FIG. 3B.

FIG. 4B is a block diagram illustrating an example of uplink traffic alignment enabled by an API in accordance with aspects of the present disclosure. As shown in FIG. 4B, API 308 may be provided between modem 320 and application client 307. In aspects, API 308 may include a software development kit (SDK) or middleware API that is exposed to an SDK or middleware software. The SDK or middleware software may be further exposed to application client 307 via a cross-layer API. In these aspects, application client 307 may make function calls, or return function calls, to or from the modem, via the cross-layer API to the SDK or middleware software, which in turns forwards the function calls or returns to the SDK/middleware API of API 308. In some aspects, API 308 may include a modem high-level operating system (HLOS) API that is exposed to an HLOS. The HLOS may be further exposed to application client 307 via an HLOS API. In these aspects, application client 307 may make function calls, or return function calls, to or from modem 320, via the HLOS API to the HLOS, which in turns forwards the function calls or returns to the modem HLOS API of API 308. In some aspects, other API exposure options may include exposing API 308 to the application client via any kind of Inter-processor communication (IPC) mechanism, via any kind of remote procedure call (RPC) mechanism, via any kind of direct function calls, via any kind of messaging interface to the Application Processor, via service APIs in a dedicated service application, etc.

As shown in FIG. 4B, uplink packets 420-422 may be aligned with respect to uplink transmit opportunities 430-432 respectively. In these aspects, API 308 may enable application client 307 to generate uplink packet 420-422 such that each uplink packet is aligned with respect to a boundary of uplink transmit opportunities 430-432. In some aspects, each uplink packet may be aligned to the start, end, or to a time within one of uplink transmit opportunities 430-432. For example, API 308 may enable application client 307 to align uplink packet 420 to a boundary of uplink transmit opportunity 430. Similarly, uplink packet 421 may be aligned to a boundary of uplink transmit opportunity 431, and uplink packet 422 may be aligned to a boundary of uplink transmit opportunity 432. In these cases, application client 307 may provide each of uplink packets 420-422 to modem 320 according to the uplink alignment. Modem 320 may then transmit uplink packets 420-422 in uplink transmissions 425-427, respectively. Uplink transmissions 425-427 may occur during each of uplink transmit opportunities 430-432, respectively. As such, by aligning the uplink packets provided to modem 320 to the uplink transmit opportunities, application client ensures that modem 320 transmits the uplink packets during a uplink transmit opportunity. In this manner, the alignment gaps between uplink transmit opportunities may be maximized, such that modem 320 may enter a sleep mode and not be awaken in between by an uplink packet to be transmitted outside a uplink transmit opportunity. For example, alignment gaps 450 and 451 may be maximized.

In aspects, uplink transmit opportunities may include CDRX on times, uplink configured grants, periodic uplink grants, and/or scheduling request (SR) occasions. For example, an uplink transmit opportunity may be defined with respect to a CDRX on time. In these cases, an uplink transmit opportunity may begin at the start time of a CDRX on time, may include the first uplink slot within a CDRX on time, and/or may include the first uplink slot likely to be used for a PUSCH transmission taking scheduling request latency into account.

In some aspects, an uplink transmit opportunity may be defined with respect to an uplink configured grant. For example, an uplink configured grant may be setup within a CDRX on time. In these cases, an uplink transmit opportunity may include the uplink slot configured for the uplink configured grant within the CDRX on time.

In some aspects, an uplink transmit opportunity may be defined with respect to a periodic uplink grant. For example, a base station (e.g., base station 105) may provide a periodic uplink grant to UE 115 via a PDCCH message (e.g., a DCI in the PDCCH message), and the periodic uplink grant may be setup within CDRX on times. In these cases, an uplink periodic grant timing may be “learned” by UE 115. An uplink transmit opportunity may include the uplink slot expected to be signaled as a periodic grant within a CDRX on time by the base station.

In some aspects, an uplink transmit opportunity may be defined with respect to an SR occasion. For example, an uplink transmit opportunity may include an SR occasion, and the SR occasion may occur within a CDRX on time.

In aspects, the techniques for uplink traffic alignment according to aspects of the present disclosure may include a semi-static signaling mechanism for signaling uplink transmit opportunities to application client 307 that may include semi-static parameters to be used in functions calls provided by API 308. In these aspects, the semi-static signaling mechanism may be applicable in implementations in which a common timer is configured between application client 307 and modem 320. The semi-static signaling mechanism may involve a periodicity of API calls. For example, in some aspects, the API calls may have a periodicity in the range of 10s of milliseconds (ms) to a few seconds. In these aspects involving semi-static signaling, offsets may be defined in terms of or with respect to the common timer between application client 307 and modem 320.

The semi-static parameters set for the semi-static signaling mechanism (which may allow for more than one set with potentially different values for the various parameters) may include parameter that may include a transmit cadence, a transmit offset, and/or a transmit window. In aspects, the transmit cadence parameter may be used to specify a cadence or frequency of uplink transmit opportunities at modem 320. For example, in aspects, the transmit cadence parameter may be used to specify the frequency of uplink transmit opportunities aligned with the CDRX duty-cycle. In aspects, the transmit cadence parameter may be specified in Hertz (Hz).

In aspects, the transmit offset parameter may be used to specify an offset of uplink transmit opportunities in terms or with respect to the common timer. In these aspects, the transmit offset parameter may be specified as a timer value. For example, a transmit offset parameter may specify an offset of uplink transmit opportunities that is equal to a CDRX offset minus the latency between sending the uplink packet from application client 307 to modem 320. In this manner, the transmit offset parameter may be used by application client 307 to ensure that an uplink packet provided to modem 320 by application client 307 may be transmitted during an uplink transmit opportunity, as the uplink packet may arrive at the modem during an uplink transmit opportunity.

In aspects, the transmit window parameter may be specified in milliseconds and may be used to specify a window of an uplink transmit opportunity. In aspects, the transmit window may be centered around, begin at the start of, or end at the end of, the transmit offset. In this manner, the transmit window may be aligned a CDRX on time.

In aspects, the semi-static parameters may be used by modem 320 to signal uplink transmit opportunities to application client 307, and by application client 307 to determine uplink transmit opportunities. Application client may use these semi-static parameters to determine an uplink transmit opportunity and to provide uplink packets to modem 320 in accordance with the uplink transmit opportunity such that the uplink packets may be transmitted in an uplink transmission during an uplink transmit opportunity.

In aspects, the techniques for uplink traffic alignment according to aspects of the present disclosure may include a dynamic signaling mechanism for signaling uplink transmit opportunities to application client 307 that may include dynamic parameters to be used in functions calls provided by API 308. In these aspects, the dynamic signaling mechanism may be applicable in implementations in which a common timer may not be configured between application client 307 and modem 320. The dynamic signaling mechanism may involve a dynamic signaling of forward/backward indications on timing of uplink traffic without a common timer. In these aspects, the API calls may not have a periodicity and may be made as often as needed (e.g., every few ms).

The dynamic parameters set for the dynamic signaling mechanism (which may allow for more than one set with potentially different values for the various parameters) may include parameters that may include a transmit cadence, a transmit window, and/or a transmit timing advance. In aspects, the transmit cadence parameter may be used to specify a cadence or frequency of uplink transmit opportunities at modem 320. For example, in aspects, the transmit cadence parameter may be used to specify the frequency of uplink transmit opportunities aligned with the CDRX duty-cycle. In aspects, the transmit cadence parameter may be specified in Hz.

In aspects, the transmit window parameter may be optional, and may be specified in milliseconds. In aspects, the transmit window parameter may be used to specify a window of an uplink transmit opportunity. In aspects, the transmit timing advance parameter may be specified in milliseconds and may be used to indicate a transmit time advance or transmit time retard. In these aspects, the transmit time of an uplink packet may be advanced or retarded in accordance with the transmit time advance. In aspects, advancing a transmit time by a transmit time advance may include moving the transmit time to a later time by the transmit time advance, and reading a transmit time by a transmit time advance may include moving the transmit time to an earlier time by the transmit time advance. In aspects, when the optional transmit window parameter is specified, the transmit timing advance may indicate a timing advance or retard of the transmit window.

In aspects, the dynamic parameters may be used by modem 320 to signal uplink transmit opportunities to application client 307, and by application client 307 to determine uplink transmit opportunities when no common timer is configured between application client 307 and modem 320. Application client 307 may use these dynamic parameters to determine an uplink transmit opportunity and to provide uplink packets to modem 320 in accordance with the uplink transmit opportunity such that the uplink packets may be transmitted in an uplink transmission during an uplink transmit opportunity.

In aspects, the techniques for uplink traffic alignment according to aspects of the present disclosure may include a no transmission (No-Tx) signaling mechanism for signaling application client 307 that that no transmission (e.g., uplink transmissions) is to take place within indicated times and/or indicated uplink transmit opportunities. In this manner, the No-Tx signaling mechanism of aspects may extend the uplink transmit opportunities signaling to allow for indications from modem 320 to application 307 of timing and/or configurations of when no transmissions may be allowed. In aspects, the No-Tx signaling mechanism may be implemented by configuring API 308 with No-Tx parameters. In aspects, the No-Tx parameters may be configured independently of uplink transmit opportunities. In aspects, when both transmit and No-Tx opportunities may be configured concurrently, an additional API parameter may be provided and used to indicate a precedence of one over the other. In aspects, one or more of the No-Tx parameter sets may be allowed. The No-Tx signaling mechanism may be useful to avoid an HLOS providing uplink traffic at times when modem 320 may not be able to handle it (e.g., during a concurrency scenario, a multi-sim paging reception, etc.).

In aspects, the No-Tx signaling mechanism may include a semi-static No-Tx parameter set that may be used when in implementations in which a common timer is configured between application client 307 and modem 320. The semi-static No-Tx parameters may include a No-Tx cadence parameter, a No-Tx offset parameter, and/or a No-Tx window parameter. In aspects, the No-Tx cadence parameter may be specified in Hz, and may be used to specify a cadence or frequency of times when transmissions (e.g., uplink transmissions) may not be allowed at modem 320. For example, times when transmissions may not be allowed may include when modem 320 may be tuned away. In aspects, the No-Tx offset parameter may be specified as a timer value and may be used to specify an offset of the No-Tx window. The No-Tx window parameter may be provided in milliseconds and may be used to specify a window when no transmissions may be allowed (e.g., when modem 320 may be tuned away).

In aspects, the No-Tx signaling mechanism may include a dynamic No-Tx parameter set that may be used when in implementations in which a common timer is not configured between application client 307 and modem 320. In aspects, the dynamic No-Tx parameters may include a No-Tx cadence parameter, a No-Tx window parameter, and/or a No-Tx timing advance parameter. In aspects, the No-Tx cadence parameter may be specified in Hz, and may be used to specify a cadence or frequency of times when transmissions (e.g., uplink transmissions) may not be allowed at modem 320. For example, times when transmissions may not be allowed may include when modem 320 may be tuned away. In aspects, the No-Tx window parameter may be optional, may be specified in milliseconds, and/or may be used to specify a window when transmissions may not be allowed at modem 320. In aspects, the No-Tx transmit timing advance parameter may be specified in milliseconds and may be used to indicate a No-Tx time advance or No-Tx time retard. In these aspects, the No-Tx time may be advanced or retarded in accordance with the No-Tx time advance. In aspects, advancing a No-Tx time by a transmit time advance may include moving the No-Tx time to a later time by the transmit time advance, and retarding a No-Tx time by a transmit time advance may include moving the No-Tx time to an earlier time by the transmit time advance. In aspects, when the optional No-Tx window parameter is specified, the No-Tx timing advance may indicate a timing advance or retard of the No-Tx window.

In aspects, the techniques for uplink traffic alignment according to aspects of the present disclosure may include detection of traffic for uplink alignment. In aspects, API 308 may include parameters for categorizing one or more IP flows as one or more sets of “uplink alignment” flows or “uplink No-Tx” flows. For example, in aspects, all IP flows may be associated with either default or one or more application provided dedicated radio bearers, all IP flows may be associated with one or more application provided traffic flow templates (TFT), all IP flows may be associated with one or more application provided quality of service flow indicators (QFIs) on either default or dedicated radio bearer, all IP flows may be associated with one or more application provided differentiated services codepoint (DSCP) markings, and/or all IP flows with a cadence that matches one or more application provided traffic cadences.

In aspects, categorizing the IP flows may include executing function calls via API 308 using one or more parameters. For example, a parameter may be provided for obtaining a list of data radio bearers (DRBs). In this case, application client 307 may provide a list of DRBs whose uplink traffic may require alignment or a No-Tx indication. A parameter may be provided for obtaining a list of TFTs. In this case, application client 307 may provide a list of TFTs, and uplink traffic matching any of the list of TFTs may be determined to require uplink alignment or a no-Tx indication. In aspects, a parameter may be provided for obtaining a list of QFIs, whose uplink traffic may require uplink alignment or a no-Tx indication. In aspects, a parameter may be provided for obtaining a list of DSCP marking. In this case, application client 307 may provide a list of DSCP markings, and uplink traffic matching any of the DSCP marking may be determined to require uplink alignment or a no-Tx indication. In aspects, a parameter may be provided for obtaining a list of traffic cadences. In this case, application client 307 may provide a list of traffic cadences, and uplink traffic matching any traffic cadences in the list may be determined to require uplink alignment or a no-Tx indication.

In aspects, the techniques for uplink traffic alignment according to aspects of the present disclosure may include implementing application input parameters for API 308. These parameter may allow application client 307 to provide input to modem 320 on various information. For example, application input parameters may include a flow identifier parameter, a traffic periodicity parameter, and/or a resync periodicity parameter.

In aspects, the flow identifier parameter may enable application client 307 to provide input of uplink 5-tuple based upon which modem 320 may identify a bearer associated with an uplink flow. This parameter may be useful in modem detection of uplink traffic to determine or infer a transmit timing advance. The traffic periodicity parameter and the resync periodicity parameter may be used to provide information from application client 307 to modem 320 based upon which modem 320 may identify a transmit offset to application client 307 and also a frequency of how often to send the transmit offset These parameters may be useful in a situation in which there is a CDRX mismatch.

FIG. 4C is a block diagram illustrating an example of a CDRX mismatch. As shown in FIG. 4C, packet arrivals may have a periodicity 470, such as based on a update rate of XR updates in split-XR implementations. In typical cases, periodicity 470 may represent XR update rates and may include update rates of 60 Hz, 90 Hz, 120 Hz, etc. However, as seen in FIG. 4C, due to the typical update rates of XR implementations, traffic arrival of uplink packets 460 and 461 may not align with available CDRX cycle lengths, which may be integer numbers. For example, the arrival time of uplink packets 460 and 461 may not align with the CDRX cycle length 475 based on which CDRX on times 480 and 481 may be based. As such, even if the uplink traffic is aligned such as by aligning uplink packet 60 to SR 490 to address latency 470, thereby transmitting uplink packet 460 in PUSCH transmission 485 during CDRX on time 480, the latency between the periodic arrival of the uplink packets and the CDRX on time may increase. For example, the latency 471 between the arrival time of uplink packet 461 and CDRX on time 481 may be greater than latency 470 of the prior CDRX cycle. This drift in the latency is caused by the mismatch between uplink packet arrival and the CDRX cycle length and may create problems even if application client 307 may adjust the time for one CDRX cycle.

In aspects, the application input parameters described above may facilitate addressing the problems arising from the CDRX mismatch described above. For example, in aspects, modem 320 may compute a transmit offset based on the indicated traffic periodicity and/or the reysnc periodicity. In aspects, the transmit offset may be calculated based on Equation 1 below.

Transmit offset=transmit occasion−min(floor(resync periodicity/traffic periodicity)*|traffic periodicity−Tx cadence|, Tx cadence) Equation 1:

In aspects, Equation 1 may enable the UE to minimize latency over the next resync periodicity. As can be seen, each packet may have a drift equal to |traffic periodicity−Tx cadence| and there may be a number of packets equal to floor(Resync periodicity/traffic periodicity). In the case where the transmit opportunity equals an SR, a transmit cadence may be equal to the SR periodicity. In the case where the transmit opportunity equals an uplink configured grant or an uplink periodic grant, the transmit cadence may be equal to the periodicity of the configured grant or the periodic grant. In some aspects, where the transmit opportunity equals a CDRX cycle start, the transmit cadence may be equal to the CDRX cycle length.

In some aspects, the transmit offset may be calculated to be equal to the transmit opportunity. In this case, traffic periodicity information at the modem may not be needed. In these aspects, the latency may start at zero and may increase min(floor(resync periodicity/traffic periodicity)*|traffic periodicity−Tx cadence|, Tx cadence).

In aspects, the transmit offset may be sent periodically to application client 307 based on the reysnc periodicity. It is noted that, in some aspects, the transmit offset may be used by application client 307 to perform resync and thereafter the application client may follow the traffic periodicity. In these cases, the latency may still drift. In a particular case, where resync periodicity>traffic periodicity*Tx cadence/|traffic periodicity−Tx cadence|, the transmit offset may be equal to the transmit cadence, in which case the average latency provided is the same as if there were no uplink alignment.

With reference back to FIG. 3, in some aspects, uplink transmission 380 may represent an aggregated uplink transmission. For example, uplink transmission 380 may include uplink traffic from one or more uplink frames that may be aggregated by UE 115 prior to transmitting uplink transmission 380 to base station 105. In aspects, aggregating one or more uplink frames may include one or more of several uplink traffic aggregating techniques in accordance with the present disclosure.

In some embodiments, aggregating one or more uplink frames may include implementing a latency tolerance API that may be used by application client 307 to indicate a tolerance of application client 307 for additional latency in return for a reduced power consumption. In aspects, the latency tolerance API may be implemented as part of API 308 described above and may be disposed between modem 320 and application client 307. In aspects, indicating a tolerance for additional latency may be beneficial, as in some cases, application client 307 may tolerate additional latency. For example, in some cases, such as in split XR or cloud-gaming applications, application client 307 may be able to accommodate a higher round trip time (RTT) when a current RTT is lower than the RTT that the application client may tolerate. This may be the case when, for example, network loading is low, server rendering time is small, asynchronous time warp (ATW) is working adequately, etc. In this cases, application client 307 may tolerate a higher latency in exchange for a reduction in the power consumption of UE 115.

In aspects, the latency tolerance API may include a latency tolerance parameter configured for application client 307 to indicate an additional latency tolerable by application client 307 in return for reduced power consumption. In aspects, modem 320 may aggregate uplink frames taking into consideration the latency tolerance indicated by application client 307 and/or until a power efficient uplink transmission occasion occurs. In aspects, uplink frame aggregation may include determining an optimal number of frames to aggregate, delaying SR and/or buffer status report (BSR) reporting, and/or skipping uplink transmissions.

In aspects, the latency tolerance API may include an aggregation level feedback API configured to enable application client 307 to receive a recommendation on the aggregation level. The aggregation level feedback API may include parameters including a frequency of uplink traffic parameter (e.g., in milliseconds), an uplink frame size (e.g., in bytes), and/or a maximum delay that an uplink frame may tolerate (e.g., in milliseconds). In aspects, the aggregation level feedback API parameters may be configured to allow application client 307 to receive a recommended aggregation level to achieve power savings. In aspects, modem 320 may receive the values of the aggregation level feedback API parameters and may compute a recommended aggregation level to achieve power savings to feedback to application client 307.

In aspects, UE 115 may determine an uplink frame aggregation level by periodically determining an optimal number of uplink frames (e.g., uplink frames as delivered by application client 307 to modem 320) that may be stored and aggregated before being transmitted on the air interface. The optimal number of uplink frames that may be aggregated may be referred to herein as Nᵤₚₗᵢₙₖ. In aspects, determining Nᵤₚₗᵢₙₖ may be based one or more of frequency of the uplink traffic, uplink frame size, maximum delay that an uplink frame may tolerate, amount of power savings that may be targeted, maximum number of PUSCH transmissions to transmit the set of aggregated frames, current radio conditions, first hybrid automatic repeat request (HARQ) transmission block error rate (BLER), HARQ RTT, which may increase latency with each HARQ retransmission, etc.

In aspects, UE 115 may store and aggregate uplink frames as delivered by the application, and the number of stored uplink frames may be referred to as N_{stored}. UE 115 may not make the N_{stored} uplink frames available for transmission on the air interface (e.g., by modem 320) until the number of stored uplink frames N_{stored} equals Nᵤₚₗᵢₙₖ. In some aspects when N_{stored} equals Nᵤₚₗᵢₙₖ, UE may transmit stored uplink frames N, or may transmit a subset of stored uplink frames up to N_{stored} aggregated frames. The determination of the stored uplink frames that may be transmitted may be based on base station scheduling. In aspects, as stored uplink frames are transmitted, UE 115 may update N_{stored} based on the number of transmitted uplink frames. In this manner, N_{stored} may be reduced as stored uplink frames are transmitted by modem 320.

In aspects, UE 115 may send a BSR to base station 105 in order to assist base station 105 with scheduling decisions. In the BSR, UE 115 may report the amount of data waiting for transmissions for each logical channel group. In implementations, all data waiting for transmission, up to packet data convergence protocol (PDCP) service data units (SDUs) for which no PDCP data protocol data units (PDUs) have been generate, may be considered for inclusion in the BSR. In aspects, in order to prevent base station 105 from allocating uplink resources when UE 115 may not wish to transmit data from application client 307 (e.g., when UE 115 is to aggregate uplink frames), the BSR may be leveraged. For example, in some aspects, UE 115 may exclude all N_{stored} uplink frames from the amount of data reported in the BSR when N_{stored} is below Nᵤₚₗᵢₙₖ. In this case, it may be assumed that the uplink frame aggregation is performed above the PDCP layer, and that uplink frames may be provided to PDCP only after uplink frame aggregation.

In some aspects, UE 115 may transmit an SR to request the base station (e.g., base station 105) to allocate uplink resources. This situation may occur when a BSR may be triggered and there are no uplink resources available for transmitting that BSR. In aspects, in order to prevent base station 105 from allocating uplink resources when UE 115 may not wish to transmit data from application client 307 (e.g., when UE 115 is to aggregate uplink frames), the SR may be leveraged. For example, in some aspects, UE 115 may exclude all N_{stored} uplink frames from the criteria used in the determination to trigger an SR when N_{stored} is below Nᵤₚₗᵢₙₖ. In this case, an SR may be trigger as a consequence of BSR trigger.

In some aspects, base station 105 may allocate more uplink resources (e.g., through uplink configured grants or through dynamic grants) than what UE 115 may intend to use, based on the uplink frame aggregation in accordance with aspects of the present disclosure. In these cases, in order to prevent unnecessary PUSCH resource allocations and/or transmissions, UE 115 may be configured, in some aspects, to skip or forego transmitting a PUSCH when N_{stored} is below Nᵤₚₗᵢₙₖ. In some aspects, UE 115 may not be allowed to skip or forego a PUSCH transmission when UCI includes multiplexed data. In this manner, when N_{stored} is below Nᵤₚₗᵢₙₖ, the amount of data from those aggregated uplink frames may be excluded from the criteria to allocated PUSCH resources.

In aspects, in order to aggregate uplink frames, UE 115 may determine to delay SR/BSR reporting and/or to skip uplink transmissions (e.g., PUSCH transmissions) until a power efficient uplink transmission occasion occurs. In aspects, a power efficient uplink transmission occasions may include transmission occasions that overlap with one or more of ongoing downlink data, a time when UE 115 is in a low-power BWP, and/or a CDRX on time.

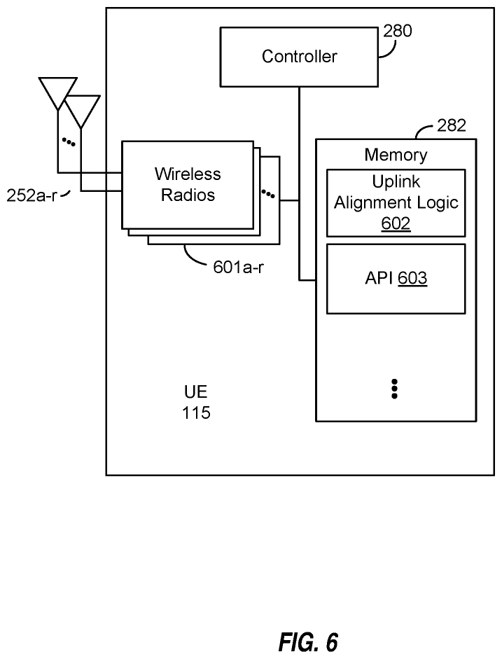

FIG. 5 is a flow diagram illustrating an example process 500 that supports mechanisms for uplink traffic alignment and uplink traffic aggregation in a wireless communication system according to one or more aspects of the present disclosure. Operations of process 500 may be performed by a UE, such as UE 115 described above with reference to FIGS. 1-3. For example, example operations (also referred to as “blocks”) of process 500 may enable UE 115 to support for uplink traffic alignment and uplink traffic aggregation. FIG. 6 is a block diagram illustrating UE 115 configured according to aspects of the present disclosure. UE 115 includes the structure, hardware, and components as illustrated for UE 115 of FIG. 2. For example, UE 115 includes controller/processor 280, which operates to execute logic or computer instructions stored in memory 282, as well as controlling the components of UE 115 that provide the features and functionality of UE 115. UE 115, under control of controller/processor 280, transmits and receives signals via wireless radios 601a-r and antennas 252a-r. Wireless radios 601a-r includes various components and hardware, as illustrated in FIG. 2 for UE 115, including modulator/demodulators 254a-r, MIMO detector 256, receive processor 258, transmit processor 264, and TX MIMO processor 266.

At block 502 of process 500, a UE (e.g., UE 115) receives, from a base station, an indication of at least one uplink transmit opportunity. In order to implement the functionality for such operations, UE 115, under control of controller/processor 280, may receive an indication of at least one uplink transmit opportunity from base station 105 via wireless radios 801a-r and antennas 252a-r. In aspects, the at least one uplink transmit opportunity may include uplink transmit opportunities determined with respect to CDRX on times.

At block 504 of process 500, UE 115 executes one or more function calls of an API (e.g., API 603) to signal the at least one uplink transmit opportunity to an application client of the UE. For example, an API may be disposed between the application client and a modem of UE 115, and the API may be implemented and/or configured with functions that may enable the mode to signal the application client the at least one uplink transmit opportunity.

At block 506 of process 500, UE 115 aligns, based on the one or more function calls of the API, uplink packets generated by the application client to the at least one uplink transmit opportunity. In order to implement the functionality for such operations, the UE, under control of controller/processor 280, executes uplink alignment logic 802, stored in memory 282. The functionality implemented through the execution environment of uplink alignment logic 802 allows for the UE to perform uplink alignment operations according to the various aspects herein. For example, using values and/or information provided via the one or more function calls, the application client may determine to generate uplink packets such that the uplink packets arrive at the modem for transmission during the at least one transmit opportunity.

At block 507 of process 500, UE 115 transmits, using the modem, an uplink transmission including the uplink packets to the base station during the at least one uplink transmit opportunity. In order to implement the functionality for such operations, UE 115, under control of controller/processor 280, may transmit, using the modem, uplink transmission including the uplink packets to base station 105 during the at least one uplink transmit opportunity via wireless radios 801a-r and antennas 252a-r.

In aspects, a common timer may be configured between the modem and the application client. In these cases, the one or more function calls of API 603 may include at least one semi-static parameter for signaling the at least one uplink transmit opportunity to the application client. The at least one semi-static parameter may include a transmit cadence parameter configured to specify a frequency of uplink transmit opportunities at the modem, a transmit offset parameter configured to specify an offset of the at least one uplink transmit opportunity with respect to the common timer, and/or a transmit window parameter configured to specify a window of the at least one uplink transmit opportunity.

In some aspects, the one or more function calls of API 603 may enable the application client to provide an input to the modem. In these cases, the one or more function calls of API 603 may include one or more of a traffic period parameter configured to allow the application client to provide information about a traffic period, and/or a resync period parameter configured to allow the application client to provide information about a resync period. In some aspects, the modem may determine a transmit offset value to include in the transmit offset parameter based on the input including one or more of a traffic period or a resync period received by the modem from the application client.

In some aspects, the modem and the application client are configured without common timer. In these cases, the one or more function calls of API 608 may include at least one dynamic parameter for signaling the at least one uplink transmit opportunity to the application client. The at least one dynamic parameter may include a transmit cadence parameter configured to specify a frequency of uplink transmit opportunities at the modem, a transmit window parameter configured to specify a window of the at least one uplink transmit opportunity, and/or a transmit timing advance parameter configured to specify a transmit time advance or transmit time retard.

In some aspects, a no-transmission indication may be provided to the application client. In these cases, the no-transmission indication may indicate at least one period of time during which no uplink transmissions are allowed by the modem. The no-transmission indication may be used when a common timer is configured between the modem and the application client. In this case, the no-transmission indication may include at least one semi-static parameter including a no-transmit cadence parameter configured to specify a frequency of periods of time during which no uplink transmissions are allowed by the modem, a no-transmit offset parameter configured to specify an offset of the at least one period of time during which no uplink transmissions are allowed by the modem, and/or a no-transmit window parameter configured to specify a window during which no uplink transmissions are allowed by the modem.

In some cases, the no-transmission indication may be used when the modem and the application client are configured without common timer. In this case, the no-transmission indication may include at least one dynamic parameter including a transmit cadence parameter configured to specify a frequency of periods of time during which no uplink transmissions are allowed by the modem, a no-transmit window parameter configured to specify a window during which no uplink transmissions are allowed by the modem, and/or a no-transmit timing advance parameter configured to indicate a no-transmit time advance or no-transmit retard.

In aspects, the at least one uplink transmit opportunity may include at least one CDRX on time, at least one uplink configured grant, at least one periodic uplink grant, and/or at least one SR occasion.

In some aspects, a base station (e.g., base station 105) may perform a process for uplink traffic alignment in which the base station may transmit, to a UE (e.g., UE 115) an indication of at least one uplink transmit opportunity. In aspects, the at least one uplink transmit opportunity may be determined by the base station based on CDRX settings determined on downlink burst arrival times, as described above. The UE may perform uplink traffic alignment and may transmit aligned uplink transmissions to the base station in accordance with aspects of the present disclosure. The base station may receive the aligned uplink transmissions from the UE.

In one or more aspects, techniques for supporting mechanisms for uplink traffic alignment and uplink traffic aggregation in a wireless communication system according to one or more aspects may include additional aspects, such as any single aspect or any combination of aspects described below or in connection with one or more other processes or devices described elsewhere herein. In a first aspect, supporting mechanisms for uplink traffic alignment and uplink traffic aggregation in a wireless communication system may include an apparatus configured to receive, from a base station, an indication of at least one uplink transmit opportunity, and to execute one or more function calls of an API to signal the at least one uplink transmit opportunity to an application client of the UE. In these aspects, the API is disposed between the application client and a modem of the UE. The apparatus is further configured to align, based on the one or more function calls of the API, uplink packets generated by the application client to the at least one uplink transmit opportunity, and to transmit, using the modem, an uplink transmission including the uplink packets to the base station during the at least one uplink transmit opportunity. Additionally, the apparatus may perform or operate according to one or more aspects as described below. In some implementations, the apparatus includes a wireless device, such as a UE. In some implementations, the apparatus may include at least one processor, and a memory coupled to the processor. The processor may be configured to perform operations described herein with respect to the apparatus. In some other implementations, the apparatus may include a non-transitory computer-readable medium having program code recorded thereon and the program code may be executable by a computer for causing the computer to perform operations described herein with reference to the apparatus. In some implementations, the apparatus may include one or more means configured to perform operations described herein. In some implementations, a method of wireless communication may include one or more operations described herein with reference to the apparatus.

In a second aspect, alone or in combination with the first aspect, a common timer is configured between the modem and the application client.

In a third aspect, alone or in combination with the second aspect, the one or more function calls of the API include at least one semi-static parameter for signaling the at least one uplink transmit opportunity to the application client.

In a fourth aspect, alone or in combination with one or more of the first aspect through the third aspect, the at least one semi-static parameter includes a transmit cadence parameter configured to specify a frequency of uplink transmit opportunities at the modem.

In a fifth aspect, alone or in combination with the fourth aspect, the at least one semi-static parameter includes a transmit offset parameter configured to specify an offset of the at least one uplink transmit opportunity with respect to the common timer; or a transmit window parameter configured to specify a window of the at least one uplink transmit opportunity.

In a sixth aspect, alone or in combination with one or more of the fourth aspect through the fifth aspect, the at least one semi-static parameter includes a transmit window parameter configured to specify a window of the at least one uplink transmit opportunity.

In a seventh aspect, alone or in combination with one or more of the first aspect through the sixth aspect, the application client provides, based on the at least one or more function calls of the API, an input to the modem including one or more of a traffic period or a resync period.

In an eighth aspect, alone or in combination with one or more of the first aspect through the seventh aspect, the transmit offset parameter includes a value determined by the modem based on the input including one or more of a traffic period or a resync period received by the modem from the application client.

In a ninth aspect, alone or in combination with one or more of the first aspect through the eighth aspect, the modem and the application client are configured without common timer.

In a tenth aspect, alone or in combination with the ninth aspect, the one or more function calls of the API include at least one dynamic parameter for signaling the at least one uplink transmit opportunity to the application client.

In an eleventh aspect, alone or in combination with one or more of the first aspect through the tenth aspect, the at least one dynamic parameter includes one or more of a transmit cadence parameter configured to specify a frequency of uplink transmit opportunities at the modem, a transmit window parameter configured to specify a window of the at least one uplink transmit opportunity, and/or a transmit timing advance parameter configured to specify a transmit time advance or transmit time retard.

In a twelfth aspect, alone or in combination with one or more of the first aspect through the eleventh aspect, the techniques of the first aspect include providing a no-transmission indication to the application client, wherein the no-transmission indication indicates at least one period of time during which no uplink transmissions are allowed by the modem.

In a thirteenth aspect, alone or in combination with one or more of the first aspect through the twelfth aspect, a common timer is configured between the modem and the application client.

In a fourteenth aspect, alone or in combination with the thirteenth aspect, the no-transmission indication includes at least one semi-static parameter.

In a fifteenth aspect, alone or in combination with one or more of the thirteenth aspect through the fourteenth aspect, at least one semi-static parameter includes a no-transmit cadence parameter configured to specify a frequency of periods of time during which no uplink transmissions are allowed by the modem, a no-transmit offset parameter configured to specify an offset of the at least one period of time during which no uplink transmissions are allowed by the modem and/or a no-transmit window parameter configured to specify a window during which no uplink transmissions are allowed by the modem.

In a sixteenth aspect, alone or in combination with one or more of the first aspect through the fifteenth aspect, the modem and the application client are configured without common timer.

In a seventeenth aspect, alone or in combination with the sixteenth aspect, the no-transmission indication includes at least one dynamic parameter.

In an eighteenth aspect, alone or in combination with one or more of the sixteenth aspect through the seventeenth aspect, the at least one dynamic parameter includes a transmit cadence parameter configured to specify a frequency of periods of time during which no uplink transmissions are allowed by the modem, a no-transmit window parameter configured to specify a window during which no uplink transmissions are allowed by the modem, and/or a no-transmit timing advance parameter configured to indicate a no-transmit time advance or no-transmit retard.

In a nineteenth aspect, alone or in combination with one or more of the first aspect through the eighteenth aspect, the at least one uplink transmit opportunity includes at least one CDRX on time, at least one uplink configured grant, at least one periodic uplink grant, and/or at least one scheduling request (SR) occasion.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-6 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single-or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method of wireless communication performed by a user equipment (UE), the method comprising:
receiving, from a base station, an indication of at least one uplink transmit opportunity;
executing one or more function calls of an application programming interface (API) to signal the at least one uplink transmit opportunity to an application client of the UE, wherein the API is disposed between the application client and a modem of the UE;
aligning, based on the one or more function calls of the API, uplink packets generated by the application client to the at least one uplink transmit opportunity; and
transmitting, using the modem, an uplink transmission including the uplink packets to the base station during the at least one uplink transmit opportunity.

2. The method of claim 1, wherein a common timer is configured between the modem and the application client, and wherein the one or more function calls of the API include at least one semi-static parameter for signaling the at least one uplink transmit opportunity to the application client.

3. The method of claim 2, wherein the at least one semi-static parameter includes one or more of:
a transmit cadence parameter configured to specify a frequency of uplink transmit opportunities at the modem;
a transmit offset parameter configured to specify an offset of the at least one uplink transmit opportunity with respect to the common timer; or
a transmit window parameter configured to specify a window of the at least one uplink transmit opportunity.

4. The method of claim 3, wherein the application client provides, based on the at least one or more function calls of the API, an input to the modem including one or more of a traffic period or a resync period.

5. The method of claim 4, wherein the transmit offset parameter includes a value determined by the modem based on the input including one or more of a traffic period or a resync period received by the modem from the application client.

6. The method of claim 1, wherein the modem and the application client are configured without common timer, and wherein the one or more function calls of the API include at least one dynamic parameter for signaling the at least one uplink transmit opportunity to the application client.

7. The method of claim 6, wherein the at least one dynamic parameter includes one or more of:
a transmit cadence parameter configured to specify a frequency of uplink transmit opportunities at the modem;
a transmit window parameter configured to specify a window of the at least one uplink transmit opportunity; or
a transmit timing advance parameter configured to specify a transmit time advance or transmit time retard.

8. The method of claim 1, further comprising:
providing a no-transmission indication to the application client, wherein the no-transmission indication indicates at least one period of time during which no uplink transmissions are allowed by the modem.

9. The method of claim 8, wherein a common timer is configured between the modem and the application client, and wherein the no-transmission indication includes at least one semi-static parameter, and wherein the at least one semi-static parameter includes one or more of:
a no-transmit cadence parameter configured to specify a frequency of periods of time during which no uplink transmissions are allowed by the modem;
a no-transmit offset parameter configured to specify an offset of the at least one period of time during which no uplink transmissions are allowed by the modem; or
a no-transmit window parameter configured to specify a window during which no uplink transmissions are allowed by the modem.

10. The method of claim 8, wherein the modem and the application client are configured without common timer and wherein the no-transmission indication includes at least one dynamic parameter, and wherein the at least one dynamic parameter includes one or more of:
a transmit cadence parameter configured to specify a frequency of periods of time during which no uplink transmissions are allowed by the modem;
a no-transmit window parameter configured to specify a window during which no uplink transmissions are allowed by the modem; or
a no-transmit timing advance parameter configured to indicate a no-transmit time advance or no-transmit retard.

11. The method of claim 1, wherein the at least one uplink transmit opportunity includes one or more of:
at least one connected discontinuous reception (CDRX) on time;
at least one uplink configured grant;
at least one periodic uplink grant; or
at least one scheduling request (SR) occasion.

12. A user equipment (UE) comprising:
a memory storing processor-readable code; and
at least one processor coupled to the memory, the at least one processor configured to execute the processor-readable code to cause the at least one processor to perform operations comprising:
receiving, from a base station, an indication of at least one uplink transmit opportunity;
executing one or more function calls of an application programming interface (API) to signal the at least one uplink transmit opportunity to an application client of the UE, wherein the API is disposed between the application client and a modem of the UE;
aligning, based on the one or more function calls of the API, uplink packets generated by the application client to the at least one uplink transmit opportunity; and
transmitting, using the modem, an uplink transmission including the uplink packets to the base station during the at least one uplink transmit opportunity.

13. The UE of claim 12, wherein a common timer is configured between the modem and the application client, and wherein the one or more function calls of the API include at least one semi-static parameter for signaling the at least one uplink transmit opportunity to the application client.

14. The UE of claim 13, wherein the at least one semi-static parameter includes one or more of:
a transmit cadence parameter configured to specify a frequency of uplink transmit opportunities at the modem;
a transmit offset parameter configured to specify an offset of the at least one uplink transmit opportunity with respect to the common timer; or
a transmit window parameter configured to specify a window of the at least one uplink transmit opportunity.

15. The UE of claim 14, wherein the application client provides, based on the at least one or more function calls of the API, an input to the modem including one or more of a traffic period or a resync period.

16. The UE of claim 14, wherein the transmit offset parameter includes a value determined by the modem based on the input including one or more of a traffic period or a resync period received by the modem from the application client.

17. The UE of claim 12, wherein the modem and the application client are configured without common timer, and wherein the one or more function calls of the API include at least one dynamic parameter for signaling the at least one uplink transmit opportunity to the application client.

18. The UE of claim 17, wherein the at least one dynamic parameter includes one or more of:
a transmit cadence parameter configured to specify a frequency of uplink transmit opportunities at the modem;
a transmit window parameter configured to specify a window of the at least one uplink transmit opportunity; or
a transmit timing advance parameter configured to specify a transmit time advance or transmit time retard.

19. The UE of claim 12, wherein the operations further comprise:
providing a no-transmission indication to the application client, wherein the no-transmission indication indicates at least one period of time during which no uplink transmissions are allowed by the modem.

20. The UE of claim 19, wherein a common timer is configured between the modem and the application client, and wherein the no-transmission indication includes at least one semi-static parameter, and wherein the at least one semi-static parameter includes one or more of:
a no-transmit cadence parameter configured to specify a frequency of periods of time during which no uplink transmissions are allowed by the modem;
a no-transmit offset parameter configured to specify an offset of the at least one period of time during which no uplink transmissions are allowed by the modem; or
a no-transmit window parameter configured to specify a window during which no uplink transmissions are allowed by the modem.

21. The UE of claim 19, wherein the modem and the application client are configured without common timer and wherein the no-transmission indication includes at least one dynamic parameter, and wherein the at least one dynamic parameter includes one or more of:
a transmit cadence parameter configured to specify a frequency of periods of time during which no uplink transmissions are allowed by the modem;
a no-transmit window parameter configured to specify a window during which no uplink transmissions are allowed by the modem; or
a no-transmit timing advance parameter configured to indicate a no-transmit time advance or no-transmit retard.

22. The UE of claim 12, wherein the at least one uplink transmit opportunity includes one or more of:
at least one connected discontinuous reception (CDRX) on time;
at least one uplink configured grant;
at least one periodic uplink grant; or
at least one scheduling request (SR) occasion.

23. A non-transitory computer-readable medium storing instructions that, when executed by a processor, cause the processor to perform operations comprising:
receiving, from a base station, an indication of at least one uplink transmit opportunity;
executing one or more function calls of an application programming interface (API) to signal the at least one uplink transmit opportunity to an application client of the UE, wherein the API is disposed between the application client and a modem of the UE;
aligning, based on the one or more function calls of the API, uplink packets generated by the application client to the at least one uplink transmit opportunity; and
transmitting, using the modem, an uplink transmission including the uplink packets to the base station during the at least one uplink transmit opportunity.

24. The method of claim 1, wherein a common timer is configured between the modem and the application client, and wherein the one or more function calls of the API include at least one semi-static parameter for signaling the at least one uplink transmit opportunity to the application client, and

25. The method of claim 2, wherein the at least one semi-static parameter includes one or more of:
a transmit cadence parameter configured to specify a frequency of uplink transmit opportunities at the modem;
a transmit offset parameter configured to specify an offset of the at least one uplink transmit opportunity with respect to the common timer; or
a transmit window parameter configured to specify a window of the at least one uplink transmit opportunity.

26. The method of claim 3, wherein the application client provides, based on the at least one or more function calls of the API, an input to the modem including one or more of a traffic period or a resync period.

27. The method of claim 4, wherein the transmit offset parameter includes a value determined by the modem based on the input including one or more of a traffic period or a resync period received by the modem from the application client.

28. The method of claim 1, wherein the modem and the application client are configured without common timer, and wherein the one or more function calls of the API include at least one dynamic parameter for signaling the at least one uplink transmit opportunity to the application client.

29. The method of claim 6, wherein the at least one dynamic parameter includes one or more of:
a transmit cadence parameter configured to specify a frequency of uplink transmit opportunities at the modem;
a transmit window parameter configured to specify a window of the at least one uplink transmit opportunity; or
a transmit timing advance parameter configured to specify a transmit time advance or transmit time retard.

30. The method of claim 1, further comprising:
providing a no-transmission indication to the application client, wherein the no-transmission indication indicates at least one period of time during which no uplink transmissions are allowed by the modem.
